(19) United States
(12) Patent Application Publication
(10) Pub. No.: US 2012/0054779 A1
(43) Pub. Date: Mar. 1, 2012

(54) PLATFORM INDEPENDENT THIN RECLAMATION FOR SYSTEMS WITH A STORAGE USAGE MAP APPLICATION PROGRAMMING INTERFACE

(75) Inventors: Moshe Melnikov, Ramat Yishay (IL); Roee Engelberg, Tel Aviv (IL)

(73) Assignee: LSI CORPORATION, Milpitas, CA (US)

(21) Appl. No.: 12/870,880

(22) Filed: Aug. 30, 2010

(51) Int. Cl. G06F 9/44

(52) U.S. Cl. 719/328

(57) ABSTRACT

In one embodiment, a method of reclaiming data storage in a storage device slated as a reclamation target is disclosed. The method includes generating a first list of one or more portions of storage from the reclamation target that each possesses an application programming interface (API) state of unused per a system that uses the storage device. The method also includes identifying in the reclamation target, a reclamation state for each portion of storage from the first list. The method further includes comparing the API state and the reclamation state for each portion of storage in the first list. In addition, the method includes identifying a first subset of portions of storage from the first list as having a mismatched state. The method further includes converting the reclamation state of each of the portion of storage in the first subset from the used state to a marked for reclamation state.

### FIELD OF TECHNOLOGY

This disclosure relates generally to a field of storage technology and in an embodiment to a method, system and an apparatus of platform independent thin reclamation for systems with a storage usage map Application Program Interface (API).

### BACKGROUND

A thin provisioning system can allocate portions of storage which can also be referred to as chunks or blocks of storage, on a data storage device to one or more storage utilization applications. If a storage utilization application does not utilize some of the allocated portions of storage, and if the data storage device and the storage utilization application do not have an ability to reclaim those unused portions of storage, then the data storage device is not being utilized to its full potential. Furthermore the data storage device often provides storage services to multiple storage utilization applications, e.g. by exposing different volumes to the different storage utilization applications. If the different storage utilization applications have allocated significant numbers of portions of storage that are unused, then the cumulative amount of allocated but unused storage may be substantial, and the available storage in a data storage device may be seriously decreased, miscalculated or misrepresented.

A file system application designed ab initio for synchronization and thin reclamation of a thin volume typically does not have the problem of allocated portions of storage that are unused. However, there are both current and older file systems that do not support thin reclamation at all, or that do not do so in an efficient manner. Consequently, the performance of the data storage device on these systems can be compromised.

While some of legacy file systems may have an Application Programming Interface (API) that can retrieve a usage map of the storage device, thus indicating the state of each portion of storage as “used” or “unused,” the states can be stale by the time the usage map is returned. That is, during the time the API is gathering the states of the portions of storage, the storage utilization application itself may have gone back to some of the portions of storage gathered early on by the API and changed their states, e.g., from an “unused” state to a “used” state. If so, then the state in the usage table of those portions of storage whose state was later changed, e.g., typically by the storage utilization application, is now obsolete. If reclamation is then based on the usage table, this would most likely result in a loss of data for the application, which is naturally unacceptable.

### SUMMARY

Disclosed are a method, an apparatus, and a system of platform independent thin reclamation for a storage utilization application with a storage usage map Application Programming Interface (API).

In one aspect, a method of reclaiming data storage in a storage device slated as a reclamation target is disclosed. The method includes generating a first list of one or more portions of storage from the reclamation target that each possesses an application programming interface (API) state of “unused” per a system that uses the storage device. Next, the method also includes identifying in the reclamation target, a reclamation state for each portion of storage from the first list. The method further includes comparing the API state and the reclamation state for each portion of data in the first list. The reclamation target as described herein is a thin volume.

The method includes identifying a first subset of one or more portions of storage from the first list as having a mismatched state. The mismatched state may be a condition of a portion of data having a reclamation state of used and an API state of unused. The method also includes converting the reclamation state of each portion of data in the first subset from the used state to a marked for reclamation state. The portion of storage may be referred as a chunk of storage.

In addition, the method may include generating a second list of one or more portions of storage from the reclamation target that each possesses the API state of unused per a system that uses the storage device. The method may also include identifying in the reclamation target, a reclamation state for each of the portions of storage from the second list. The method may further include comparing the API state and the reclamation state for each of the portions of storage in the second list. Also, the method may include identifying a second subset of portions of storage from the second list as having the mismatched state. The mismatched state as described herein may be the one having a reclamation state of marked for reclamation and the API state of unused. The method may further include converting the reclamation state of each of the portions of storage in the second subset from a marked for reclamation state to an unused state.

In addition, the method includes transforming the reclamation state in the storage device for each of the portions of storage in the first list from any kind of reclamation state to an unused reclamation state if no access command is given to any portion of storage in the reclamation target during the method of reclaiming data storage. The access command may be any of but not limited to a read command, a write command, and a read and write command. The conversion and the transformation of a state of one or more portions of storage are performed by any of a host, an intermediate device coupled to the storage device, and the storage device, itself. However, the conversion and the transformation as described may appear as an atomic operation to a host electronic device utilizing the storage device.

In addition, the method may also include converting the reclamation state of a given portion of storage in the reclamation target from any state to the used state if the access command is received for the given portion of storage. The method may also include converting the reclamation state of each portion of storage in the reclamation target that is not in the second list and that has a reclamation state of marked for reclamation to the used state. The method may further include reclaiming data storage of the portion of storage in the reclamation target having a state of unused.

Another aspect includes a method of reclaiming data storage in a storage device intended as reclamation target. The method includes transforming a reclamation state for one or more portions of storage in the reclamation target having an API state of unused via a multiple number of stages. A first stage is configured to change the reclamation state of one or more portions of storage from a used state to a marked for reclamation state. A second stage is configured to change the reclamation state of one or more portions of storage from the marked for reclamation state to any one of a used state and an unused state depending upon whether an access command is received for the portion of data after the first stage and prior to completion of the second stage, thereby guaranteeing no loss of data. The stages as described herein may occur in a sequential manner for a given reclamation target. The stages as described herein apply only to the portions of storage in the reclamation target having the API state of unused per a system that uses the storage device. Furthermore, the states may be superseded by an access command to a given portion of storage that will then force the state of the given portion of storage to remain in a used state.

In another aspect, a storage device includes a local memory. The storage device also includes a local processor coupled to the local memory. The local processor and local memory execute instructions for a method of reclaiming data storage in a storage device intended as a reclamation target. The method includes generating a first list of one or more portions of storage from the reclamation target that possess an API state of unused per a system that uses the storage device. Next, the method also includes identifying in the reclamation target, a reclamation state for each data from the first list. The method further includes comparing the API state and the reclamation state for each of the one or more portion of storage in the first list. Further, the method identifies a first subset of one or more portions of storage from the first list as having a mismatched state, wherein the mismatched state is one having a reclamation state of used and an API state of unused. The method then includes converting the reclamation state of each of the one or more portions of storage in the first subset from the used state to a marked for reclamation state.

The method executed on the local memory and process includes generating a second list of portions of storage that possess an API state of unused per a system that uses the storage device. In addition, the method may include identifying in the reclamation target, the reclamation state for each of the portions of storage from the second list. Furthermore, the method may include comparing the API state and the reclamation state for each of the portions of storage in the second list. The method may further include identifying a second subset of one or more portions of storage from the second list as having a mismatched state. The mismatched state as described herein is one having a reclamation state of marked for reclamation and an API state of unused. The method may further include converting the reclamation state of each of portions of storage in the second subset from the marked for reclamation state to an unused state. The instructions for performing the method as described herein may be stored on a computer readable medium.

In yet another aspect, a system includes a storage device having a local memory coupled to a local processor. The system also includes a host electronic device coupled to the storage device. The host electronic device and the storage device will execute instructions for a method of reclaiming data storage in the storage device intended as a reclamation target. The method includes generating a first list of one or more portions of storage from the reclamation target that possess an API state of unused per a system that uses the storage device. The method also includes identifying in the reclamation target, a reclamation state for each portion of data from the first list.

In addition, the method includes comparing the API state and the reclamation state for each of the portions of storage in the first list. The method also includes identifying a first subset of portions of storage from the first list as having a mismatched state. The mismatched state may be the one having a reclamation state of used and an API state of unused. The method further includes converting the reclamation state of each of the portions of storage in the first subset from the used state to a marked for reclamation state.

In addition, the method includes generating a second list of portions of storage that possess an API state of unused per a system that uses the storage device. The method also includes identifying in the reclamation target, the reclamation state for each of the portions of storage from the second list. Furthermore, the method includes comparing the API state and the reclamation state for each of the portions of storage in the second list. Also, the method includes identifying a second subset of portions of storage from the second list as having a mismatched state. The mismatched state may be the one having a reclamation state of marked for reclamation and the API state of unused. Next, the method may include converting the reclamation state of each of the portions of storage in the second subset from a marked for reclamation state to an unused state.

The methods, systems, and apparatuses disclosed herein may be implemented in any means for achieving various aspects. Other features will be apparent from the accompanying drawings and from the detailed description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 is a system view illustrating a network for implementing a reclamation process, according to one or more embodiments.

FIG. 2 is a schematic representation of a data processing system that can be used for implementing a reclamation process for local data storage, according to one or more embodiments.

FIG. 3 is a schematic view illustrating state transitions of reclamation process, according to one or more embodiments.

FIG. 4 is a table view illustrating example scenarios of portions of storage for reclamation, according to one or more embodiments.

FIG. 5A is a flowchart of a process of data recovery space, according to one or more embodiments.

FIG. 5B is a continuation of FIG. 5A illustrating additional steps, according to one or more embodiments.

FIG. 5C is a continuation of FIG. 5B illustrating additional steps, according to one or more embodiments.

Other features of the present embodiments will be apparent from the accompanying drawings and from the detailed description that follows.

### DETAILED DESCRIPTION

Disclosed are a method, an apparatus and/or system of platform independent thin reclamation for systems with a storage usage map Application Programming Interface (API). Although the present embodiments have been described with reference to specific example embodiments, it will be evident that various modifications and changes may be made to these embodiments without departing from the broader spirit and scope of the various embodiments.

Thin reclamation is a process of identifying allocated but unused storage spaces in a storage devices and reclaiming the same for other purposes. In one embodiment, thin reclamation is implemented on storage devices configured as thin volumes. Although, the thin reclamation herein in described for thin volumes, the reclamation process can be extended to storage devices with fat volumes as well. Embodiments described herein are directed to illustrate platform independent thin reclamation for systems with a storage usage map API.

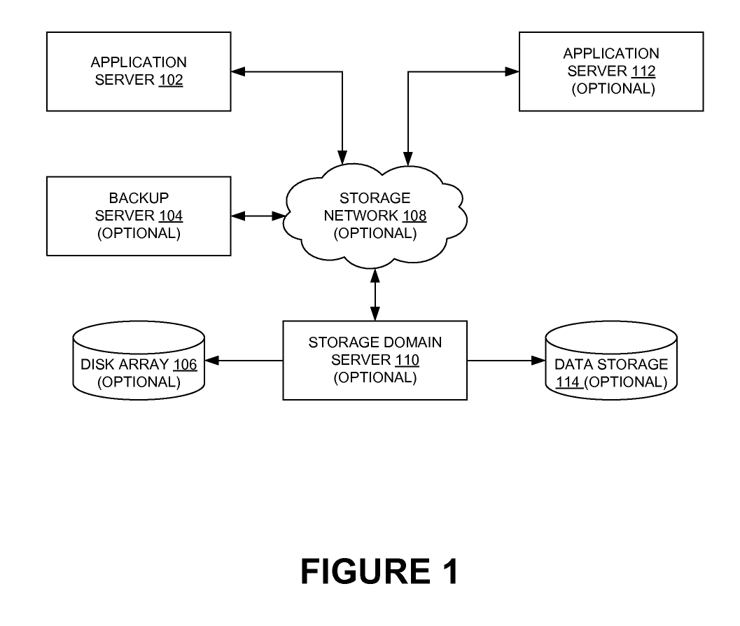

FIG. 1 is a system view illustrating a network that includes storage devices, according to one or more embodiments. As illustrated in figure, the network, inter alia, may include an application server 102, an application server 112, a backup server 104, a storage domain server 110, a disk array 106, and/or a data storage 114, communicatively coupled to each other through a storage network 108, according to one or more embodiments. In one or more embodiments, the storage network 108 may be a Local Area Network (LAN), a Wide Area Network (WAN), a Metro Area network (MAN), or other type of network of any size.

In one or more embodiments, the application server 102 and the application server 112 communicatively coupled to the storage network 108 may be any of, but are not limited to a database server, a web server, a file server, and E-mail server. In one or more embodiments, the application server 102 and the application server 112 may be configured to execute one or more server application programs. Examples of server application programs may include but not limited to a database program, a web program, a print program, an E-mail program and any other end-user software application. Alternatively, the application server 102 and the application server 112 may be the servers that are configured to execute one or more end-user application programs.

In one or more embodiments, the application servers 102 and 112 may utilize storage resources for executing one or more server application programs and for information storage. In one or more embodiments, the storage resources may include, but is not limited to the backup server 104, the disk array 106, and the data storage 114. In one or more embodiments, the disk array 106, and the data storage 114 controlled through the storage domain server 110 may be used for storing information communicated by the application server 102, the application server 112 and/or any data processing system in the network. In one or more embodiments, the storage domain server 110 may be communicatively coupled to multiple data processing systems for file sharing, automated backup, remote access, etc. In one or more embodiments, the backup server 104 may be a data processing system configured to store copies of contents of the application servers. In one or more embodiments, the backup server 104 may be used for storing contents of the application servers 102 and 112, and other devices in the storage network 108. Each of the storage resource may include one or more storage controllers and one or more interfaces. Each of the storage resources may be communicatively coupled to the storage network 108 through the interfaces.

In one or more embodiments, each of the storage resources discussed herein may be configured as thin volumes. Also, each of the storage resources may be reclamation targets. Although, the reclamation process for few example storage resources are discussed herein, the process of reclamation can be extended to other types of storage devices that are not discussed herein. In one or more embodiments, the storage device may include physical volumes. One or more physical volumes may be logically divided into several logical volumes or two or more physical volumes may be grouped logically to form a logical volume. In one or more embodiments, a term ‘a portion of storage’ may be referred to as a block of storage, a chunk of storage, storage block, a slice of storage, or any other label that describes a quantum of storage for data in any of the storage devices.

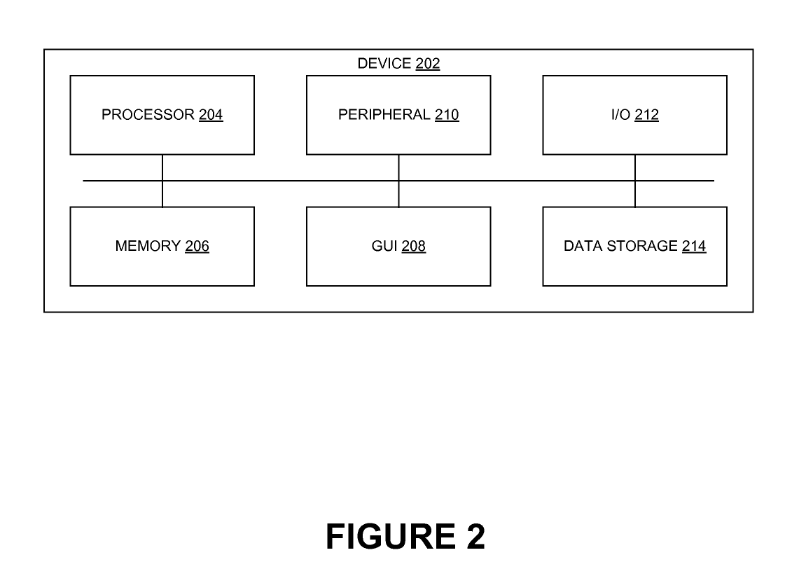

In one or more embodiments, one or more end-user application programs or other application server programs may be executed through the application server 102, the application server 112 and/or any data processing device in the storage network. An example of the data processing system is illustrated in FIG. 2. In one or more embodiments, one or more end-user application programs or application server programs that are executed by the data processing systems such as the application server 102, the application server 112 and or any other data processing system in the network may reserve storage in the storage resources. In one or more embodiment, the storage may be reserved and allocated by the storage resource as requested by the data processing systems such the application server 102, the application server 112 and/or any other data processing system in the storage network 108. Furthermore, in one or more embodiments, the data communicated while executing one or more end-user server application programs or the application server programs may be stored in the allocated reserved space in any of the storage resources in the storage network 108 configured thereof. In one or more embodiments, the data may be communicated and processed in the storage resources through an appropriate Input/Output command. However, the reserved (allocated) storage space may or may not be completely used by the end-user application program or any other application of the data processing systems that reserved that storage space. A part of the storage space that is not used by the end-user application program or applications, may remain unused until set free by the processor.

In one or more embodiments, a storage utilization application (SUA) may be used for identifying the allocated but unused storage space. In one or more embodiments, the SUA (e.g., also referred as a file system API) and a processor implementing a reclamation process may be located in the application server 102, the application server 112, or any other data processing system in the storage network 108. In one or more embodiments, the SUA may be configured to determine a state of a portion of storage, as determined by a system that uses the storage resources. In one or more embodiments, the state of a portion of storage, as determined by a system that uses the storage resource may be referred as API state. In one or more embodiments, the SUA, or system that uses the storage device, refers to a file system or other host system that controls, utilizes, and in general manages data storage, e.g., long term data storage. The SUA is distinguished from an end-user software application, such as a word processing application, a spreadsheet application or a file-based database application, in that the end-user software application is configured to use the storage utilization application in order to interface with the storage resources. Thus, the storage utilization application has its own set of rules for ensuring data integrity and determining when a portion of storage is “unused”.

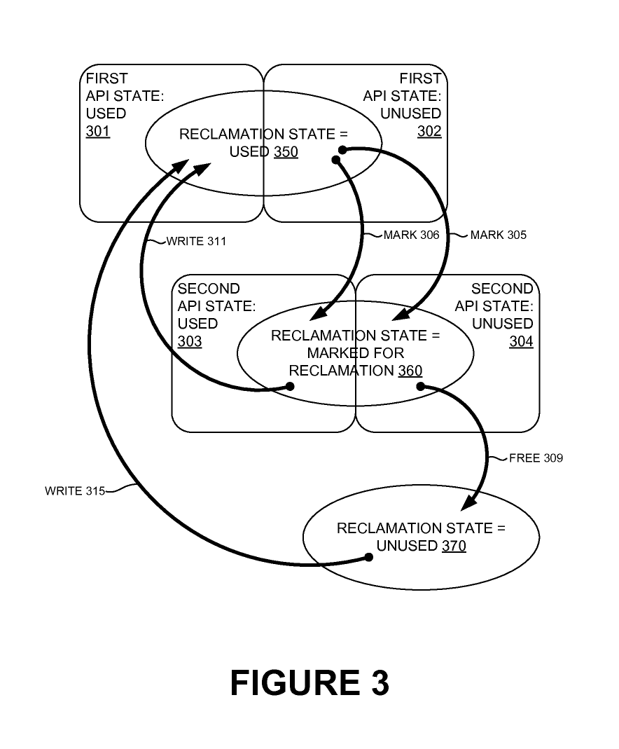

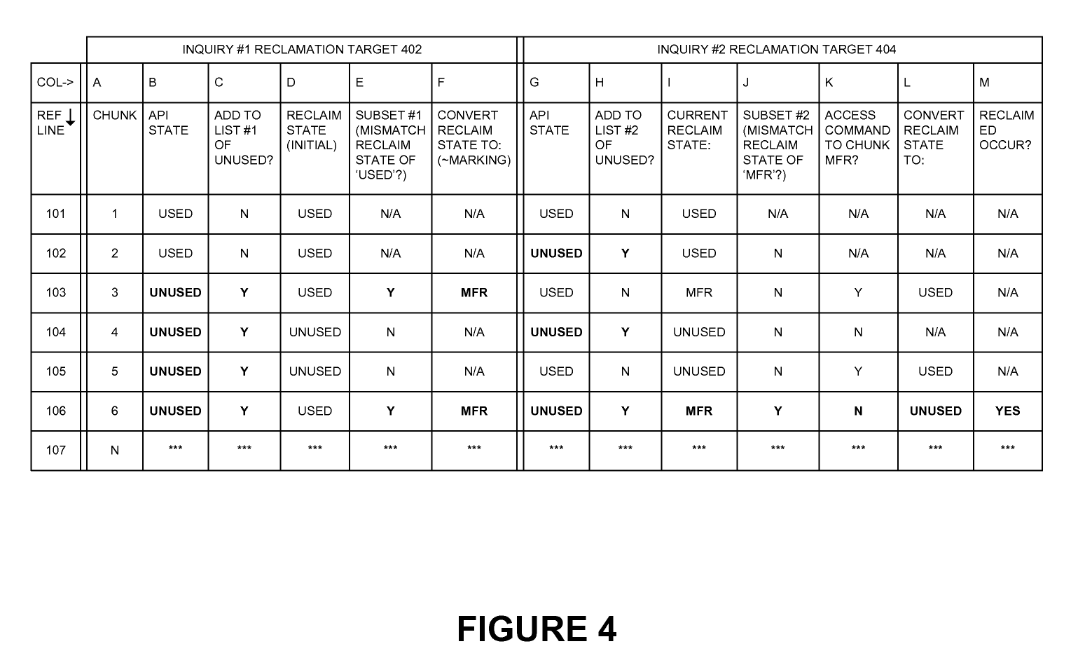

In one or more embodiments, the SUA as described herein may be configured to identify allocated but unused storage space to enable the processor to reclaim the allocated but unused memory spaces and optimize the storage space in the storage resources through a processor (e.g., storage device processor or controller) of the specific storage resource. The SUA may be configured to identify the storage portions of the storage resources to determine a reclamation state of the storage portions of one or more storage resources. Furthermore, the allocated but unused portions of storage of the storage may be recovered through a reclamation process described later. FIG. 3 and FIG. 4 illustrates the process of reclamation as performed through the file system API. The process of reclaiming allocated but unused storage of the storage resources may be implemented on any storage resource selected from a group including but not limited to a storage device, a host system, an intermediate switching device, a personal computer, the application servers, and other network computers.

FIG. 2 is an example of a device 202 (e.g., data processing system) that may include, but not limited to the application server, a storage device and a computer. In one or more embodiments, FIG. 2 can also illustrate one of the individual devices in FIG. 1, i.e. an application server, backup server, disk arrays or other data storage devices. Alternatively, device 202 can be a standalone device, such as a personal computer, a mobile device, such as a smart phone or global positioning system (GPS), a video game console, or any other device using storage. In one or more embodiments, the device 202 may include a processor 204, a memory 206, a peripheral 210, a Graphical User Interface (GUI) 208, an input/output (I/O) device 212, and data storage 214. In one or more embodiments, the processor 204 may be a component of the device 202 that is configured to execute application such as end-user application. In one or more embodiments, the peripheral 210 and the GUI 208 for additional functionality is well known in the art. In one or more embodiments, the data storage 214 may be a storage component of the device 202 with thin volumes. In one or more embodiments, the data storage 214 may be a read-only memory such as a hard disk. In addition to the data storage 214, the device 202 may also include a volatile memory 206 such as Random Access Memory (RAM).

In one or more embodiments, the reclamation process may be illustrated using a state transition diagram in FIG. 3 and using specific cases in FIG. 4. In one or more embodiments, the API state of the portion of storage represents the actual state of the portion of the storage (e.g., unused even though allocated). In one or more embodiments, the reclamation state of the portion of storage represents the state that is allocated by the storage resource. In one or more embodiments, the process of reclaiming is explained below.

Initially, in first step (stage 1), a first list of several portions of storage from the reclamation target that each possesses an API state of “unused” per a system that uses the storage resource may be generated. In addition, an initial reclamation state of each of the chunk of storage may be analyzed. In one or more embodiments, each of the portion of storage in the first list that having an API state of “unused” may be compared with its initial reclamation state. If there is a mismatch in the comparison or if the initial reclamation state of the portion of storage is “used,” then that storage portion may be identified and the reclamation state of storage portion may be converted into “marked for reclamation” (MFR) state. The comparison operation for the chunks of storage other than in the first list may not be performed as the state of API represents “used” indicating that the chunk of storage is allocated and used.

In a further step (stage 2), a second list of one or more portions of storage from the reclamation target that possesses an API state of “unused” per a system that uses the storage resources may be generated. In addition, a current reclamation state of each of the chunk of storage may be analyzed. In one or more embodiments, each of the portions of storage in the second list that an API state of “unused” may be compared with its current reclamation state through a processor. In one or more embodiments, the process may be performed in the storage device, application servers, a host device or any other device concerned thereof. If the current reclamation state of the portion of storage is “MFR,” then that storage portion may be identified and the reclamation state of that storage portion may be converted into “unused” state for freeing it for other purposes. In one or more embodiments, a second stage may change the reclamation state of one or more portions of storage from the marked for reclamation state to any one of a used state and an unused state depending upon whether an access command may be received for the portion of storage after the first stage and prior to completion of the second stage, thereby guaranteeing no loss of data. In one or more embodiments, the steps as described herein may occur in a sequential manner for a given reclamation target. In one or more embodiments, the access command may be a write and/or read input/output commands. Other cases are apparent and are explained in forthcoming figures.

Each of the conversion and the transforming of a state of one or more portion of storage may be performed by any of the devices in the network such as a host, an intermediate device coupled to the storage device, and the storage device, itself. However, the conversion and transformation operation may appear as an atomic operation to a device (e.g., host device or device executing the process) utilizing the storage device.

FIG. 3 is a schematic view illustrating state transitions in a storage device, according to one or more embodiments. FIG. 4 is a table view illustrating the state transitions of FIG. 3, according to one or more embodiments. In one or more embodiments, the SUA is activated upon activation of any end-user application. In one or more embodiments, one or more functions associated with analysis of storage may be invoked to analyze the storage utilized by the end-user application or any other application. Furthermore, the storage utilized by the end-user application may be optimized. In one example embodiment, analysis and optimization of the storage in two steps as illustrated in FIG. 4. A subset of list of cases is provided in FIG. 4 for analysis of different states associated with the chunks of storage for providing better understanding of reclamation process as described herein one or more embodiments.

As illustrated in FIG. 4, in one or more embodiments, the Inquiry#1 Reclamation target 402 may be a process where the utilized storage space may be analyzed using the API state and the reclamation state to identify and mark the chunks of storage that can be reclaimed. Similarly, Inquiry#2 Reclamation target 404 may be a process where the processor scans for the API state and the reclamation state of the chunks of storage to confirm the API state and the reclamation state for performing a reclamation operation.

Columns A represents a reference chunk of storage, column B represents a first API state, column C represents an addition of the chunk of storage with “unused” API state into a list 1, and column D represents reclamation state of the chunk of storage. Column E represents a first condition (explained later), Column F represents reclamation state conversion, column G represents a second API state of chunk of storage, and column H represents an addition of the chunk of storage with “unused” API state into list 2. Column I represents current reclamation state of chunk of storage, column J represents second condition (explained later), and column K represents application access command to the chunk of storage marked for reclamation. Column L represents conversion of reclamation state after detection of reclamation state of chunk of storage or application of access command on the chunk of storage and column M represents reclamation. The reference rows 101-107 represent a set of cases that can occur in reclamation process.

Case 101 and 102: In one or more embodiments, the states of the chunk (e.g., portion as aforementioned) of storage 1 and 2 as in case 101 and case 102 may be identified having reclamation states and API states as “used” in Inquiry#1 Reclamation target 402. The “used” state for both API state and reclamation state indicates that the chunk of storage 1 and 2 are actually allotted and used. Furthermore, in Inquiry #2 Reclamation target 404, the API state and the reclamation state of chunk of storage 1 is identified as “used” and may be determined through the processor that the chunk of storage 1 is not for reclamation. Furthermore, the second API state of chunk of storage 2 may be identified as “unused” and the second reclamation state may be identified as “used.” A condition (second condition) may be evaluated to determine whether the chunk of storage 2 can be reclaimed. In one or more embodiments, the second condition may be a test of mismatch between the second reclamation state and second API state in process Inquiry #2 Reclamation Target 404, where the second reclamation state requires the chunk of storage under consideration (chunk of storage 2) with a reclamation state as “MFR” and the second API state requires the chunk of storage under consideration (chunk of storage 2) with an API state as “unused.” Since the test of mismatch may not be possible due to the prerequisites as described, the chunk of storage 2 may not be considered for reclamation.

Alternatively, in one or more embodiments, if the mismatch between the second reclamation state and the second API state in process Inquiry #2 Reclamation Target 404 occurs, then the condition is evaluated to be true rendering the processor to reclaim the chunk of storage under consideration. In one or more embodiments, if the mismatch between the second reclamation state and the second API state in process Inquiry #2 Reclamation Target 404 occurs, then the condition is evaluated to be false rendering the chunk of storage not applicable for reclamation. The condition as described above when evaluated for case 101 and case 102 for chunk of storage 1 and 2 in Inquiry #2 Reclamation target 404 returns false rendering the chunk of storage 1 and 2 not eligible for reclamation.

Case 103: In one or more embodiments, in Inquiry #1 Reclamation Target 402 for case 103, the API state of chunk of storage 3 may be identified as “unused” and the reclamation state may be identified as “used.” Since the API state of chunk of storage 3 as identified as “unused,” in one or more embodiments, the chunk of storage 3 may be added to a list #1 of unused. In addition, the reclamation state of chunk of storage 3 may be identified as “used.” Furthermore, a condition (first condition) may be evaluated to determine whether the chunk of storage 3 can be reclaimed. In one or more embodiments, the first condition may be a test of mismatch between the first reclamation state and first API state in process Inquiry #1 Reclamation Target 402, where the initial reclamation state requires the chunk of storage 3 under consideration as ‘used’ and the first API state requires the chunk of storage 3 under consideration as “unused.” Since, the initial reclamation state of the chunk of storage 3 under consideration is ‘used’ and the first API state requires the chunk of storage 3 under consideration as “unused,” the condition on chunk of storage 3 may be evaluated. As the first condition evaluates true or due to successful mismatch, the reclamation state of chunk of storage 3 may be converted to MFR.

Furthermore, in Inquiry #2 Reclamation Target 404, the API state of the chunk of storage 3 may be identified as ‘used’ and the reclamation state may be identified as “MFR.” The API state of the chunk of storage 3 may be identified as “used” because the chunk of storage 3 may be accessed for a different purpose through an access command. Since, the chunk of storage 3 is now used for other purpose, the chunk of storage 3 becomes ineligible for reclamation.

Case diagram for case 103 as illustrated in FIG. 3: In one or more embodiments, the first API state of the chunk of storage 3 may be identified as ‘unused’ and the initial reclamation state may be identified as “used”. The first API state and the initial reclamation state may be represented as First API state: Unused 302 and Reclamation State =Used 350, in FIG. 3. In one or more embodiments, the chunk of storage 3 may be added to the list 1 of “unused” and is marked for reclamation as described above. This can be represented by transition: MARK 306 and Reclamation State =Marked for Reclamation 360, in FIG. 3.

In one or more embodiments, the second API state of the chunk of storage 3 may be identified as “used” and the reclamation state of the chunk of storage 3 may be recognized as “MFR” by the processor. The second API state and the reclamation state may be identified as Second API state: Used 303 and Reclamation State =Marked for Reclamation 360, as illustrated in FIG. 3. In one or more embodiments, the chunk of storage 3 may not be added to the list 2 of “unused” and to the subset of list 2 and may receive an access command to convert the reclamation state to “used” by the processor. This can be represented by the arrow 311 WRITE and 350 Reclamation State=Used, as illustrated in FIG. 3.

Case 104: In one or more embodiments, in Inquiry #1 Reclamation Target 402, the first API state of chunk of storage 4 may be identified as “unused” and the reclamation state may be identified as “unused.” In one or more embodiments, the chunk of storage 4 may be added to a list 1 of “unused.” Furthermore, as aforementioned, a first condition may be evaluated (mismatch Reclamation state of “Used”) to determine whether the chunk of storage 4 can be reclaimed. The condition may evaluate to false as there is no mismatch between the API state and the reclamation state of the chunk of storage 4. The reclamation state of chunk of storage is maintained as it is.

In one or more embodiments, in Inquiry #2 Reclamation Target 404, the second API state of the chunk of storage 4 is be identified as “unused” and the reclamation state may be identified as “unused”. In one or more embodiments, the chunk of storage 4 may be added to the list 2 of unused. Since the API state of the chunk of storage 4 is identified as “unused” and the reclamation state is identified as “unused”, the second condition to determine whether the chunk of storage 4 can be reclaimed may evaluate false. Therefore, the chunk of storage 4 may not be considered for reclamation.

The case diagram for case 104: In one or more embodiments, the first API state of the chunk of storage 4 may be recognized as “unused” and the initial reclamation state may be recognized as ‘unused’ by the processor (not shown in FIG. 3).

In one or more embodiments, the second API state of the chunk of storage 4 may be recognized as “unused” and the reclamation state may be recognized as “unused” by the processor. In one or more embodiments, there may be no transition at all as the chunk of storage is already identified as “unused”. In one or more embodiments, the chunk of storage 4 may be added to the list 2 of ‘unused’ and is not be added to the subset of list 2. Further, the chunk of storage 4 may not receive an access command thereby not qualifying for reclamation.

Case 105: In one or more embodiments, in Inquiry #1 Reclamation Target 402 for case 105, the first API state of chunk of storage 5 may be identified as ‘unused’ in and the reclamation state may be identified as “unused.” As both the API state and the reclamation state are ‘unused’, the chunk of storage 105 represents an unused state. Furthermore, as aforementioned, the first condition may be evaluated (mismatch Reclamation state of “Used”) to determine whether the chunk of storage 5 can be reclaimed. The condition may evaluate to false as there is no mismatch between the API state and the reclamation state of the chunk of storage 5. The reclamation state of chunk of storage is maintained as it is.

In one or more embodiments, for case 105, in Inquiry #2 Reclamation Target 404, the second API state of the chunk of storage 5 may be identified as “used” and the reclamation state of the chunk of storage 5 may be identified as “unused”. The second API state of the chunk of storage 5 may be identified as “used” because the chunk of storage 5 may be accessed by a storage application through the access command. In one or more embodiments, the chunk of storage 5 may not be added to the list 2 of unused. Furthermore, since the API state of the chunk of storage is “used,” the chunk of storage 105 may not be considered for reclamation.

The case diagram for case 105: In one or more embodiments, the first API state of the chunk of storage 5 may be recognized as ‘unused’ and the initial reclamation state may be identified as “unused” (not shown in FIG. 3).

In one or more embodiments, the second API state of the chunk of storage 5 may be recognized as “used” and the reclamation state may be identified as “unused”. In one or more embodiments, the chunk of storage 4 is added to the list 2 of “unused” and is not be added to the subset of list 2 and may receive an access command to convert the reclamation state to “used”. The transition of the reclamation state from “unused” to “used” may be represented by an arrow WRITE 315 and Reclamation State =Used 350. The chunk of storage 5 may not be eligible for reclamation.

Case 106: In one or more embodiments, in Inquiry #1 Reclamation Target 402 for case 106, the API state of chunk of storage 6 may be identified as ‘unused’ and the reclamation state of chunk of storage 6 may be identified as “used”. In one or more embodiments, the chunk of storage 6 may be added to a list 1 of unused. Furthermore, as aforementioned, the first condition may be evaluated (mismatch Reclamation state of “Used”) to determine whether the chunk of storage 6 can be reclaimed. The condition may evaluate to true as there is mismatch between the API state and the reclamation state of the chunk of storage 6. The reclamation state of chunk of storage may be changed to MFR.

In one or more embodiments, for case 106, in Inquiry #2 Reclamation Target 404, the chunk of storage 6 may be recognized as ‘unused’ in the second API state and the reclamation state may be recognized as ‘MFR’ (Marked For Reclamation). In one or more embodiments, the chunk of storage 6 may be added to the list 2 of unused. Furthermore, as aforementioned, the second condition may be evaluated (mismatch Reclamation state of ‘Used’) to determine whether the chunk of storage 6 can be reclaimed. The condition may evaluate to true as there is a mismatch between the API state (‘unused’) and the reclamation state of the chunk of storage 6 (MFR). The reclamation state of chunk of storage may be changed to unused state.

The case diagram for case 106 is illustrated in FIG. 3. In one or more embodiments, the first API state of the chunk of storage 6 may be recognized as ‘unused’ and the initial reclamation state may be recognized as ‘used’ by the processor. The first API state and the initial reclamation state may be represented as First API state: Unused 302 and Reclamation State =Used 350, as illustrated in FIG. 3. In one or more embodiments, the chunk of storage 3 may be added to the list 1 of unused and is marked for reclamation as described above. This is represented by the arrow MARK 305 and Reclamation State =Marked for Reclamation 360, as illustrated in FIG. 3.

In one or more embodiments, the second API state of the chunk of storage 6 may be recognized as ‘unused’ and the reclamation state may be recognized as ‘MFR’ by the processor. The second API state and the reclamation state may be represented as Second API state: Unused 304 and Reclamation State =Marked for Reclamation 360, as illustrated in FIG. 3. In one or more embodiments, the chunk of storage 6 may be added to the list 2 of ‘unused’ and to the subset of list 2. Furthermore, the chunk of storage 6 may not receive an access command. The reclamation state may be changed from marked for reclamation to ‘unused’ by the processor and the chunk of storage 6 may be reclaimed through reclamation. The transition may be illustrated in FIG. 3 through an arrow FREE 309 from the Reclamation State =Marked for Reclamation 360 to Reclamation state=Unused 370.

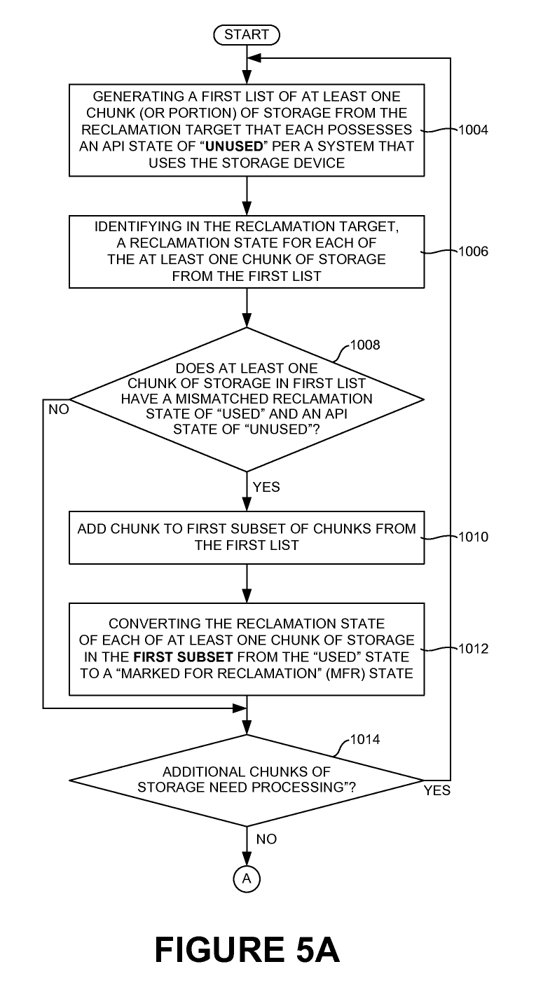

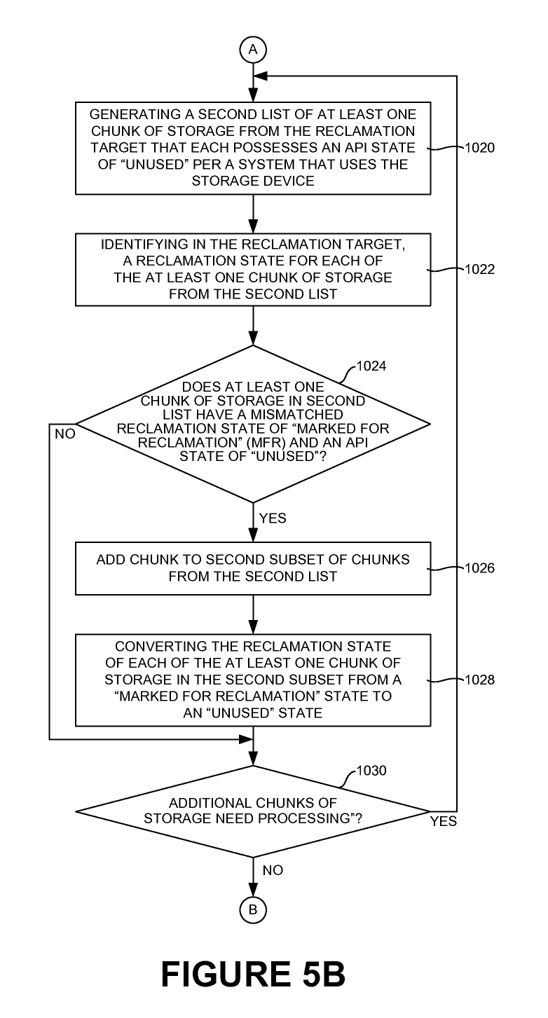

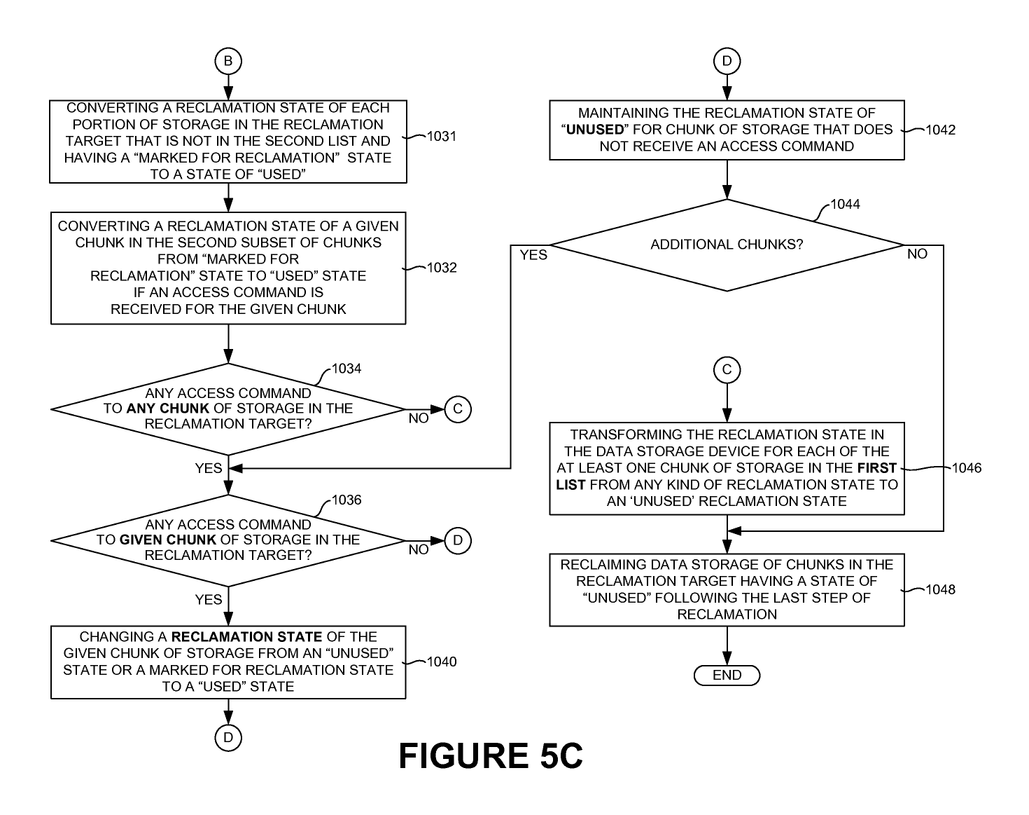

In one or more embodiments, FIG. 5A may illustrate steps of Inquiry #1 Reclamation Target 402 of FIG. 4 and FIG. 5B and FIG. 5C may illustrate steps of Inquiry #2 Reclamation Target 404 of FIG. 4.

FIG. 5A is a flowchart of a process of reclamation in a data storage device, according to one or more embodiments. In one or more embodiments, the data storage device may be any data storage system, hand held device, tablets, servers, computing device, network, etc. In one or more embodiments, the data storage device may be on an on-die cache, local memory, external memory, network attached storage, and/or remote storage device. In one or more embodiments, in step 1004, a first list of one or more chunk (or portion) of storage may be generated from the reclamation target that each posses an API state of unused per a system that may use the storage resource. In one or more embodiments, the list may be a grouping, a table, etc. of identification of specific chunks (or portions) of storage. In one or more embodiments, the storage may be range of quantity of chunks: zero chunks (moot case) that have an unused state; or could be one or more or all the chunks in a thin volume that may be unused. In one or more embodiments, the “first list of one or more chunks” may be generated by any device implementing the reclamation process. The algorithm may be run by a host processor, by a storage device, by a switch or a server in between the host processor and the storage device, etc.

In one or more embodiments, unused storage may be chunk of storage that is provisioned by thin provision, but chunk would not have been used or could have been relieved, so storage resource may not needed for file anymore. In one or more embodiments, per a system is a library call command for a host OS that may be requested by any device in the system (for e.g., a storage device, the host OS itself, a switch between the host and the storage device, etc.) that may return chunks having an API state of “unused” or state of “used” or a list of both. Boolean logic may be used to develop a final list of “unused” API state. For example, if the list provided by API usage map is “used” chunks, then the reclamation algorithm may find the desired list of chunks with an ‘unused’ API state by subtracting the superset of all chunks in the given API.

In one or more embodiments, API usage map may be a file system API usage map, files, raw database (database API) usage, methods of not using files to store tables (not file based), for e.g., database using an intermediate file storage, arranged in any other type of; use table provided by the direct consumer of the data storage device. In one or more embodiments, in step 1008, a condition (e.g., first condition) may be applied to determine whether the chunk of storage in first list has a mismatched reclamation state of “used” and an API state of ‘unused.’

In one or more embodiments, in step 1006, the reclamation state may be identified in the reclamation target for each of the chunk of storage from the first list. In one or more embodiments, the API state and the reclamation state may be compared for each portion of storage in the first list. In one or more embodiments, the comparison may be performed by any device in the system. In one or more embodiments, in step 1008, a first condition may be applied to determine if the chunk of storage in first list may have a mismatched reclamation state of used and an API state of unused. In one or more embodiments, if the first condition evaluates true, then in step 1010, a chunk of storage may be added to first subset of chunks from the first list. In one or more embodiments, if the first condition evaluates false, then step 1014 may be executed.

In one or more embodiments, in step 1012, the reclamation state of each portion of storage in the first subset may be converted from the used state to a marked for reclamation state at the reclamation target. In one or more embodiments, in step 1014, a first condition may be applied whether the additional chunks of storage need processing. In one or more embodiments, if the first condition evaluates true, then step 1004 may be repeated. In one or more embodiments, if the first condition evaluates false, then step 1020 may be executed.

FIG. 5B is a continuation of FIG. 5A illustrating additional steps, according to one or more embodiments. In one or more embodiments, in step 1020, a second list of one or more chunk of storage may be generated from the reclamation target that each may possess an API state of “unused” per a system that uses the storage resources. The second list may be a newly initiated API call and would not be updated API usage map from first call. In one or more embodiments, in step 1022, the reclamation state may be identified in the reclamation target for each of the chunk of storage from the second list. In one or more embodiments, the API state and the reclamation state may be compared for each portion of storage in the second list. In one or more embodiments, in step 1024, a condition (e.g., second condition) may be applied to determine if the chunk of storage in the second list has a mismatched reclamation state of marked for reclamation (MFR) and an API state of unused.

In one or more embodiments, if the condition evaluates true, then in step 1026, a chunk of storage may be added to second subset of chunks from the second list. In one or more embodiments, if the condition evaluates false then step 1030 may be executed. In one or more embodiments, in step 1028, the reclamation state of each of the chunk of storage in the second subset may be converted from a marked for reclamation state at the reclamation target to an unused state.

In one or more embodiments, in step 1030, a condition may be applied whether the additional chunks of storage need to be processed. In one or more embodiments, if the condition evaluates true, then step 1020 may be executed to process additional chunk of storage. In one or more embodiments, if the condition evaluates false then step 1031 may be executed. In one or more embodiments, in step 1031, a reclamation state of each portion of storage which is not in the second list and has a reclamation state of marked for reclamation is converted in the reclamation target to a state of used.

FIG. 5C is a continuation of FIG. 5B illustrating additional steps, according to one or more embodiments. In one or more embodiments, in step 1032, a reclamation state of a given chunk may be converted in the second subset of chunks from marked for reclamation state to used state if an access command may be received for the given chunk. In one or more embodiments, in step 1034, a condition may be applied whether any access command to any chunk of storage in the reclamation target may be received. In one or more embodiments, if the condition evaluates true then step 1036 may be executed (described later). In one or more embodiments, if the condition evaluates false then step 1046 may be executed (described later).

In one or more embodiments, the access command may be an item selected from a group that may include a read command, a write command, or both a read and write command, or any other command that may change the substantive data in the memory, or the need for an API to access a given chunk of storage in memory.

In one or more embodiments, the converting and the transforming of a state of one or more portions of storage may be performed by an item selected from a group that may include a host, an intermediate device coupled to the storage device, and the storage device, itself. In one or more embodiments, converting and transforming may appear as but not limited to an atomic operation to a host electronic device that may utilize the storage device.

In one or more embodiments, in step 1036, a condition may be applied whether any access command to given chunk of storage in the reclamation target may be received. In one or more embodiments, if the condition evaluates true then step 1040 may be performed. In one or more embodiments, if the condition evaluates false then step 1042 may be performed. In one or more embodiments, in step 1040, a reclamation state of the given chunk of storage may be changed from an unused state or any state to a used state if the access command is received for the given portion of storage. In one or more embodiments, any state may refer to marked for reclamation state or an unused state.

In one or more embodiments, in step 1042, the reclamation state of unused may be maintained for chunk of storage that does not receive an access command. In one or more embodiments, in step 1044, a condition may be applied to determine whether there are additional chunks of storage existing for reclamation. In one or more embodiments, if the condition evaluates true then step 1036 may be executed. In one or more embodiments, if the condition evaluates false then step 1048 may be executed. In one or more embodiments, in step 1046, the reclamation state in the data storage device for each of the chunk of storage in the first list may be transformed from any kind of reclamation state to an unused reclamation state if no access command may be given to any portion of storage in the reclamation target during the method of reclaiming data storage. In one or more embodiments, the no access command may be either a no write command or no write or read command. In one or more embodiments, in step 1048, the data storage of chunks may be reclaimed in the reclamation target that may have a state of unused that may follow the last step of reclamation.

Although the present embodiments have been described with reference to specific example embodiments, it will be evident that various modifications and changes may be made to these embodiments without departing from the broader spirit and scope of the various embodiments.

What is claimed:

1. A method of reclaiming data storage in a storage device slated as a reclamation target, the method comprising:
generating a first list of at least one portion of storage from the reclamation target that each possesses an application programming interface (API) state of unused per a system that uses the storage device;
identifying in the reclamation target, a reclamation state for each of the at least one portion of storage from the first list;
comparing the API state and the reclamation state for each of the at least one portion of storage in the first list;
identifying a first subset of at least one portion of storage from the first list as having a mismatched state, wherein the mismatched state is one having a reclamation state of used and an API state of unused; and
converting the reclamation state of each of the at least one portion of storage in the first subset from the used state to a marked for reclamation state.

2. The method of claim 1 further comprising:
generating a second list of at least one portion of storage from the reclamation target that each possesses the API state of unused per a system that uses the storage device;
identifying in the reclamation target, a reclamation state for each of the at least one portion of storage from the second list;
comparing the API state and the reclamation state for each of the at least one portion of storage in the second list;
identifying a second subset of at least one portion of storage from the second list as having the mismatched state, wherein the mismatched state is one having a reclamation state of marked for reclamation and the API state of unused; and
converting the reclamation state of each of the at least one portion of storage in the second subset from a marked for reclamation state to an unused state.

3. The method of claim 2 further comprising:
transforming the reclamation state in the storage device for each of the at least one portion of storage in the first list from any kind of reclamation state to an unused reclamation state if no access command is given to any portion of storage in the reclamation target during the method of reclaiming data storage.

4. The method of claim 3 wherein the reclamation target is a thin volume, wherein the at least one portion of storage is a chunk of storage, and wherein the access command is an item selected from a group consisting of: a read command, a write command, and a read and write command.

5. The method of claim 1 wherein at least one of the converting and the transforming of a state of the at least one portion of storage is performed by an item selected from a group consisting of: a host, an intermediate device coupled to the storage device, and the storage device, itself.

6. The method of claim 1 wherein converting and transforming appears as an atomic operation to a host electronic device utilizing the storage device.

7. The method of claim 2 further comprising:
converting the reclamation state of a given portion of storage in the reclamation target from any state to the used state if the access command is received for the given portion of storage.

8. The method of claim 2 further comprising:
converting the reclamation state of each portion of storage in the reclamation target that is not in the second list and that has a reclamation state of marked for reclamation to the used state.

9. The method of claim 1 further comprising:
reclaiming data storage of the portion of storage in the reclamation target having a state of unused.

10. A method of reclaiming data storage in a storage device intended as a reclamation target, the method comprising:
transforming a reclamation state for at least one portion of storage in the reclamation target having an API state of unused via a plurality of stages wherein a first stage will change the reclamation state of the at least one portion of storage from a used state to a marked for reclamation state and wherein a second stage will change the reclamation state of the at least one portion of storage from the marked for reclamation state to any one of a used state and an unused state depending upon whether an access command is received for the portion of storage after the first stage and prior to completion of the second stage, thereby guaranteeing no loss of data.

11. The method of claim 10 wherein the plurality of stages occur in a sequential manner for a given reclamation target.

12. The method of claim 10 wherein the plurality of stages applies only to the at least one portion of storage in the reclamation target having the API state of unused per a system that uses the storage device

13. The method of claim 10 wherein states associated with the plurality of stages are superseded by an access command to a given portion of storage that will then force the state of the given portion of storage to remain in a used state.

14. A storage device comprising:
a local memory;
a local processor coupled to the local memory; and
wherein the local processor and local memory execute instructions for a method of reclaiming data storage in a storage device intended as a reclamation target, the method comprising:
generating a first list of at least one portion of storage from the reclamation target that possess an API state of unused per a system that uses the storage device;
identifying in the reclamation target, a reclamation state for each of the at least one portion of storage from the first list;
comparing the API state and the reclamation state for each of the at least one portion of storage in the first list;
identifying a first subset of at least one portion of storage from the first list as having a mismatched state, wherein the mismatched state is one having a reclamation state of used and an API state of unused; and
converting the reclamation state of each of the at least one portion of storage in the first subset from the used state to a marked for reclamation state.

15. The storage device of claim 14 wherein the method executed on the local memory and process further comprises:
generating a second list of at least one portion of storage that possess an API state of unused per a system that uses the storage device;
identifying in the reclamation target, the reclamation state for each of the at least one portion of storage from the second list;
comparing the API state and the reclamation state for each of the at least one portion of storage in the second list;
identifying a second subset of at least one portion of storage from the second list as having a mismatched state, wherein the mismatched state is one having a reclamation state of marked for reclamation and an API state of unused; and
converting the reclamation state of each of the at least one portion of storage in the second subset from the marked for reclamation state to an unused state.

16. The storage device of claim 14 wherein the instructions for performing the method are stored on a computer readable medium.

17. A system comprising:
a storage device having a local memory coupled to a local processor;
a host electronic device coupled to the storage device; and
wherein the host electronic device and the storage device will execute instructions for a method of reclaiming data storage in the storage device intended as a reclamation target, the method comprising:
generating a first list of at least one portion of data from the reclamation target that possess an API state of unused per a system that uses the storage device;
identifying in the reclamation target, a reclamation state for each of the at least one portion of storage from the first list;
comparing the API state and the reclamation state for each of the at least one portion of storage in the first list;
identifying a first subset of at least one portion of storage from the first list as having a mismatched state, wherein the mismatched state is one having a reclamation state of used and an API state of unused; and
converting the reclamation state of each of the at least one portion of storage in the first subset from the used state to a marked for reclamation state.

18. The system of claim 15 wherein the method executed on the local memory and local processor further comprises:
generating a second list of at least one portion of storage that possess an API state of unused per a system that uses the storage device;
identifying in the reclamation target, the reclamation state for each of the at least one portion of storage from the second list; and

19. The system of claim 18 further comprising:
comparing the API state and the reclamation state for each of the at least one portion of storage in the second list; and
identifying a second subset of at least one portion of storage from the second list as having a mismatched state, wherein the mismatched state is one having a reclamation state of marked for reclamation and the API state of unused.

20. The system of claim 19 further comprising:
converting the reclamation state of each of the at least one portion of storage in the second subset from a marked for reclamation state to an unused state.
